(19) United States
(12) Patent Application Publication
(10) Pub. No.: US 2006/0009999 A1
(43) Pub. Date: Jan. 12, 2006

(54) Contract term updates

(76) Inventors: Karen A. Gee, Heidelberg (DE); Klaus Kohlmaier, Leimen (DE)

Correspondence Address: KENYON & KENYON, ONE BROADWAY, NEW YORK, NY, 10004, US

(21) Appl. No.: 11/026,096

(22) Filed: Jan. 3, 2005

Related U.S. Application Data
(60) Provisional application No. 60/585,592, filed on Jul. 7, 2004.

(51) Int. Cl. G06F 17/60

(52) U.S. Cl. 705/1; 705/80

(57) ABSTRACT

A contract term updating system monitors of the expiration of contract terms stored in a contract database. A processing device receives the contract terms nearing expiration and generates an update form that includes the contract terms to be updated. The processing device may convert the form into a format to be accessible using an electronic mail delivery system and provides the update form to an output device. The electronic message may then be electronically transmitted to the parties to the contract, providing an automatic reminder that specifically noted contract terms are subject to expiration and the update form allows for the renewal or renegotiations of the contract terms. The parties renegotiate the terms of the contract, update the update form and provide the update form back to the processing device. The updated contract terms are therein stored back in the contract database.

### BACKGROUND

The present invention relates generally to the area of software and more specifically to the maintenance of contracts having valid contract terms.

Currently, problems arise in maintaining electronic documentation of sales contracts. In a typical approach, purchase contracts include multiple contract terms relating to varying aspects of the sales agreement between a purchaser and a supplier. In these negotiated contracts, contract terms are applicable for a defined period of time.

A current approach is to manually note expiration dates for contract terms in the physical paper contract. This approach is problematic when dealing with a large number of contracts having multiple contract terms. Furthermore, unless the parties to the contract record the expiration dates on a calendar or in an electronic calendar software application, problems can arise from parties letting contract terms expire. Furthermore, this approach requires not only the negotiation of the contract, but then the further manual step of recording the expiration date(s) for the contract terms. As noted above, in a typical purchase agreement, the number of contracts can make this process extremely time-consuming for the purchaser and the supplier and also susceptible to human input errors.

Furthermore, with the growth of computing systems and automated processes, the current approach fails to take advantage of benefits offered by computing operations. While many contracts are negotiated in-person between a supplier and purchaser, a growing trend includes paperless negotiations. As electronic contracts include numerous contract terms, it can become even more difficult to maintain an accurate and proper record of expiration dates of contract terms when the contract is negotiated using electronic only forms.

Another problem arises regarding software integration requirements for electronic systems. An individual supplier works with many purchasers and vice versa. These different parties engage in many different contracts. Often times, different suppliers and vendors use different software applications. Therefore, problems arise in congruency of electronic documentation across multiple vendor-specific systems. Parties are also reluctant to acquire new software products outside of their own due to costs, maintenance, training and compatibility issues.

A current contract database system utilizes a host application granting user access to a central database. The purchaser hosts this system and a supplier may be allowed to access the database using a designated portal. This database system stores the contract information in a standard EDI format. This system does not allow for offline usability, as the system requires the supplier to physically access the database through the dedicated portal. This system also does not allow offline usability based on data formatting, as the data is not in a human readable format, but rather is configured solely for internal software data processing.

Therefore, with the existing systems using paper reminders or electronic database structures, there is not an automatic reminder system. The current systems also do not allow for efficient user access, including offline access and/or readable access from the database. As such, there exists a need for maintaining the validity of contract terms and updating contract terms prior to or upon the expiration of the contract terms.

### BRIEF DESCIRPTION OF THE DRAWINGS

FIG. 1 illustrates a block diagram of one embodiment of an apparatus for maintaining and updating contract terms;

FIG. 2 illustrates a graphical representation of an exemplary embodiment of a contract having multiple contract terms;

FIG. 3 illustrates a flow diagram of one embodiment of the operation a system for updating contract terms;

FIG. 4 illustrates a block diagram of a system providing for the maintenance and update of contract terms between a purchaser and a supplier; and

FIG. 5 illustrates a flowchart of one embodiment of a method for updating contract terms.

### DETAILED DESCRIPTION

A contract term updating system allows for the automatic notification of the pending expiration of contract terms. Through the use of a processing device in conjunction with a contract database, the contract terms to be updated are generated into a human readable form. The human readable form also allows for a greater degree of flexibility, such as being attachable to an electronic message and formatted for subsequent printing. Moreover, the contract term updating system, through the generation of an update form allows for contract terms to be updated from an offline connection. Therefore, a high degree of mobility is allowed through reading and usage of the update form outside of a direct connection to the contract database.

The contract term updating system also provides an internal data input accuracy check through defined ranges for input terms. Data fields in the update form can have ranges to prevent accidental data entry of incorrect contract terms, thereby not only increasing the accuracy of data input but also providing a high degree of error reduction. Furthermore, using the update form reduces software requirements for parties to the contract. Through a defined platform structure, such as a commercially available browser or viewer application, extraneous and/or new software requirements for integration of the contract term updating system are eliminated.

As described below, a contract term updating system automatically notifies a user of the expiration of contract terms. Through the storage of contract terms in a contract database, the contract terms may be easily and readily monitored based on expiration dates. Therefore, purchasers and suppliers do not need to utilize secondary tracking systems to monitor expiration dates, such as hand-written notes on calendars or notes within electronic calendars. Moreover, purchasers and suppliers do not need to then regenerate contracts with the contract terms to be updated. Furthermore, purchasers and suppliers do not need to spend time attending to these matters, which may include numerous contracts, each having a large number of contract terms. The system can access the database to retrieve contract terms based on search terms including expiration dates and the parties to the contract.

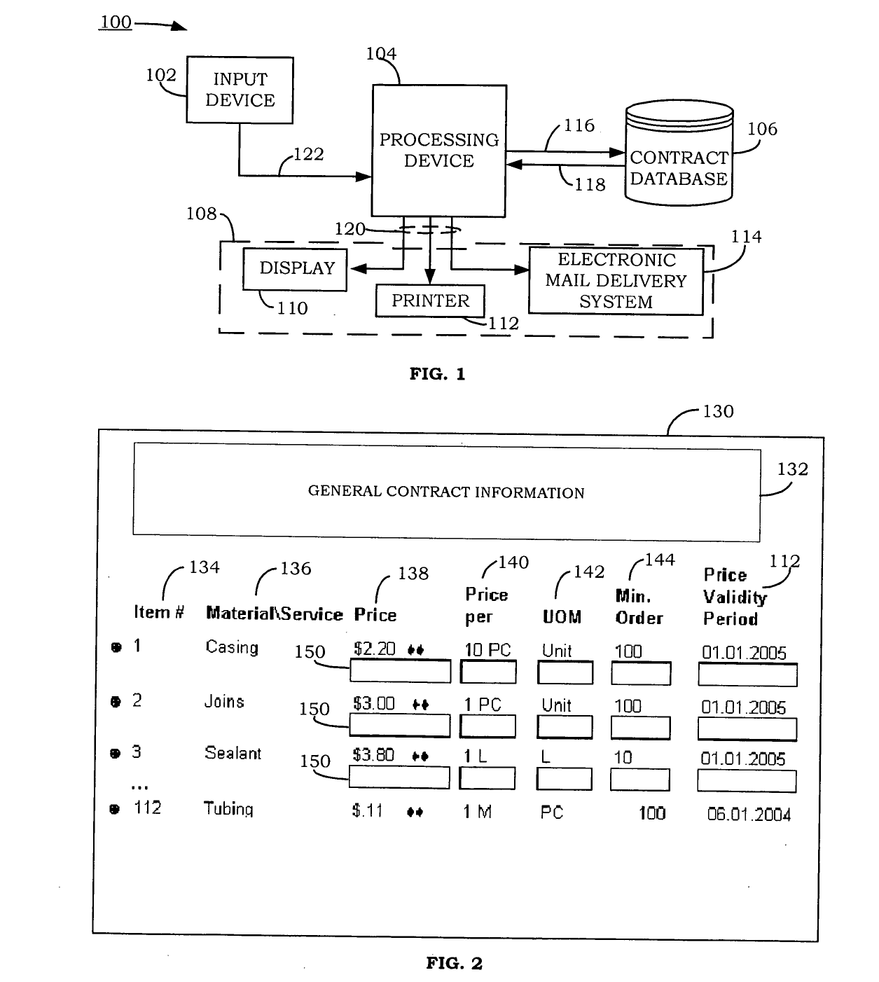

FIG. 1 illustrates a block diagram of one embodiment of an apparatus 100 for contract term updates. The apparatus 100 includes an input device 102, a processing device 104, a contract database 106 and an output device 108. The input device 102 may be any suitable device capable of receiving user input or an input signal, such as, but not limited to, a physical device like a keyboard, keypad, a touchscreen and a scanner with original content recognition software or a processing device like an electronic mail delivery system including a receiving device.

The processing device 104 may be, but not limited to, a single processor, a plurality of processors, a DSP, a microprocessor, an ASIC, a state machine, or any other implementation capable of processing and executing software. The term processing device should not be construed to refer exclusively to hardware capable of executing software and may implicitly include DSP hardware, ROM for storing software, RAM, and any other volatile or non-volatile storage medium.

The contract database 106 may be any suitable memory or storage location operative to store sales information or any other suitable information therein including, but not limited to, a single memory, a plurality of memory locations, shared memory, CD, DVD, ROM, RAM, EEPROM, optical storage, microcode, or any other non-volatile storage capable of storing information. The output device 108 may be any suitable device capable providing an output, such as but not limited to a display 110, a printer 112 and/or an electronic mail delivery system 114.

In one embodiment, the processing device 104 provides a data retrieval signal 116 to the contract database 106. The data retrieval signal 116 may be an operative command to retrieve contract terms where the command may include a date or range of dates corresponding to potential expiration dates for contract terms stored in the contract database. As discussed in further detail below, the contract database 106 stores data representing terms of a plurality of contracts which include one or more contract terms that define the conditions of a contract between a purchaser and a supplier. In another embodiment, the contract database 106 may automatically generate the search based on date terms received from any suitable source, such as the processing device 104.

The contract database 106 thereupon searches the contracts terms data associated with the contracts stored therein. The contract terms data may occur in business objects having parameters allowing for searching, wherein each contract term is a specific business object recorded and stored in the contract database. After searching various contract terms data, the processing device 104 receives the contract terms 118 within a time period of expiration.

The processing device 104 thereupon generates an update form 120 which is provided to the output device 108. The update form 120 may be any electronic formation of data fields including the contract terms 118 from the contract database 106. The update form 120 may also include contract terms not nearing expiration, to provide a greater degree of clarity for parties seeking to update the contract terms.

In one embodiment, the update form 120 may be provided to the display 110. Upon the display 110, the update form 120 is capable of being viewed. Based upon technologies within the display 110, the display 110 may also provide functionality of the input device 102 if the display 110 is a touchscreen allowing for direct user input. In another embodiment, the display 110 may work in conjunction with the input device 102, wherein the display 110 provides visual queues for data entry using the input device 102, in response to operations performed by the processing device 104. In this embodiment, data input operations using the update form 120 visible on the display 110 with input from the input device 102 would be in accordance with known interactive data retrieval operations.

In another embodiment, the processing device 104 provides the update form 120 to the printer 112. Using proper printer driver technology, the processing device 104 formats the update form 120 to be printable using the printer 112, thereupon generating a hard-copy of the update form. In one embodiment, hand notes and revisions may be entered onto the paper form and the input device 102 may be a keyboard or keypad accepting input keystroke commands or may be a scanner using original content recognition (OCR) software to receive the contract updates.

In another embodiment, the processing device 104 provides the update form 120 to the electronic mail delivery system 114. The electronic mail delivery system may be any suitable system allowing for electronic communication, such as but not limited to electronic mail (email), paging, messaging systems, e.g. SMS, EMS, MMS, transmissions using wired and/or wireless transmission systems.

The processing device 104 may format the update form to be associated with the electronic mail delivery system 114. For example, the processing device 104 may format the update form to be in a third-party application for attachment to an electronic mail message, such as a browser or viewer application. In another example, the processing device 104 may format the update form in any format consistent with protocols of the electronic mail delivery system 114 such that the update form is contained within an electronic message.

FIG. 1 illustrates the generation of the update form and delivery of the update form to the output device 108. FIG. 2 illustrates an exemplary embodiment of an update form 130 including a header 132 displaying general contract information. The general contract information may be any suitable information, such as invoice or contract reference numbers and/or the names and address of parties to the contract. In one exemplary embodiment, the form 130 includes data assimilated in tabular form including designated columns with rows of corresponding information. For example, columns may include item numbers 134, material or service descriptions 136, price terms 138, price per unit terms 140, units of measurement terms 142, minimum order terms 144 and validity period terms 146.

In the exemplary update form, items numbered 1, 2 and 3 have validity periods 146 terminating on the date Jan. 1, 2005. Assuming that present date is within a predefined time interval of the date Jan. 1, 2005, such as within 30 days, 60 days or 90 days for example, the update form 130 includes update fields 150 for the input of new terms. In this embodiment, the presence of the update fields 150 indicate the contract term is to be updated, wherein excluding the update field, such as illustrated with item number 112, may indicate the validity period is not near expiration. In another embodiment, the update form may contain update fields 150 for all terms and the users can ignore update fields 150 for non-expiration terms.

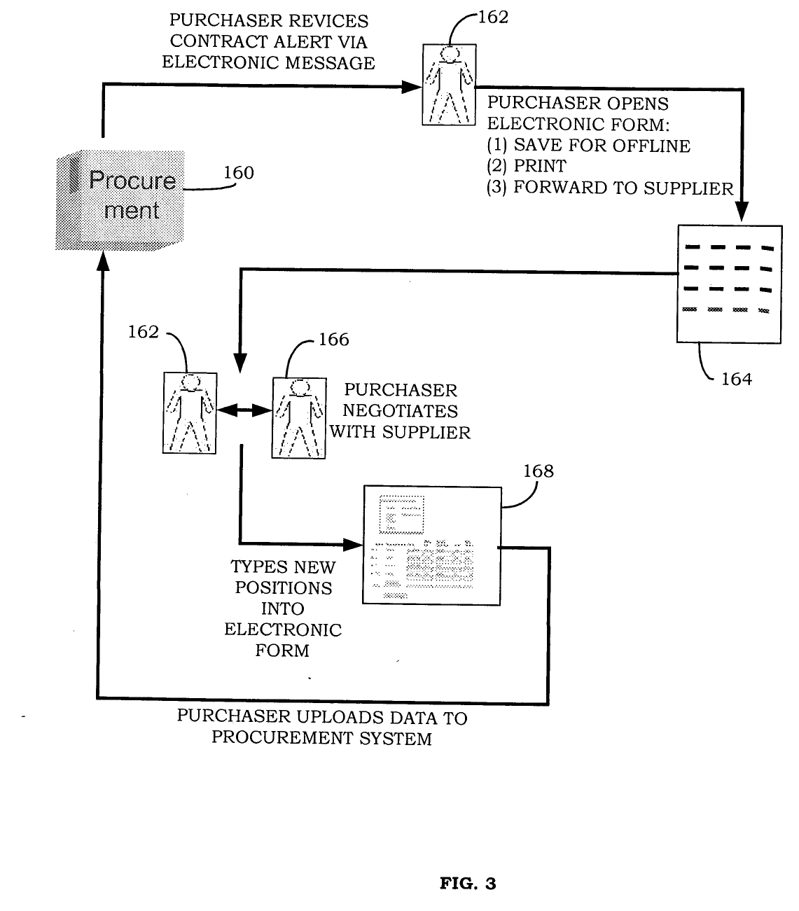

FIG. 3 illustrates a representative diagram of one embodiment of the process of updating contract terms using the system described above. A procurement system 160 provides to a purchaser 162 a contract alert using the electronic messaging system. In one embodiment, this alert may include an update form embedded or attached thereto. In another embodiment, the alert may include an active link, such as a hyperlink, or a directory listing for the retrieval of the update form. In another embodiment, the alert may simply include a notice that a contract includes term(s) having expired or nearing expiration and requesting the purchaser to retrieve an update form.

The purchaser 162 opens the electronic form 164; similar to the exemplary form 130 of FIG. 2. The purchaser 162 may then save the form 164 for offline usage, print the form 164 or forward the form 164 to a supplier, in three exemplary embodiments. Thereupon, the purchaser 162 negotiates with a supplier 166 regarding the contract terms. This negotiation may be conducted in-person, via telephone, via exchanged messages, via exchanged version of the update form or any other suitable negotiation and resolution technique.

Upon resolution of the updated contract terms, the new positions, updated contract terms, are typed into the electronic form 168. In another embodiment, the positions may be handwritten and using OCR software, the form may be scanned with the terms being electronically recognized. The purchaser 162 uploads data to the procurement system 160.

The procurement system 160 may use these contract terms for billing and other transactional activities in an overall business processing system and customer service management environment. In one embodiment, verification of input information may be verified using electronic signatures, encryption techniques or any other suitable means to authenticate the purchaser 162 and supplier 166.

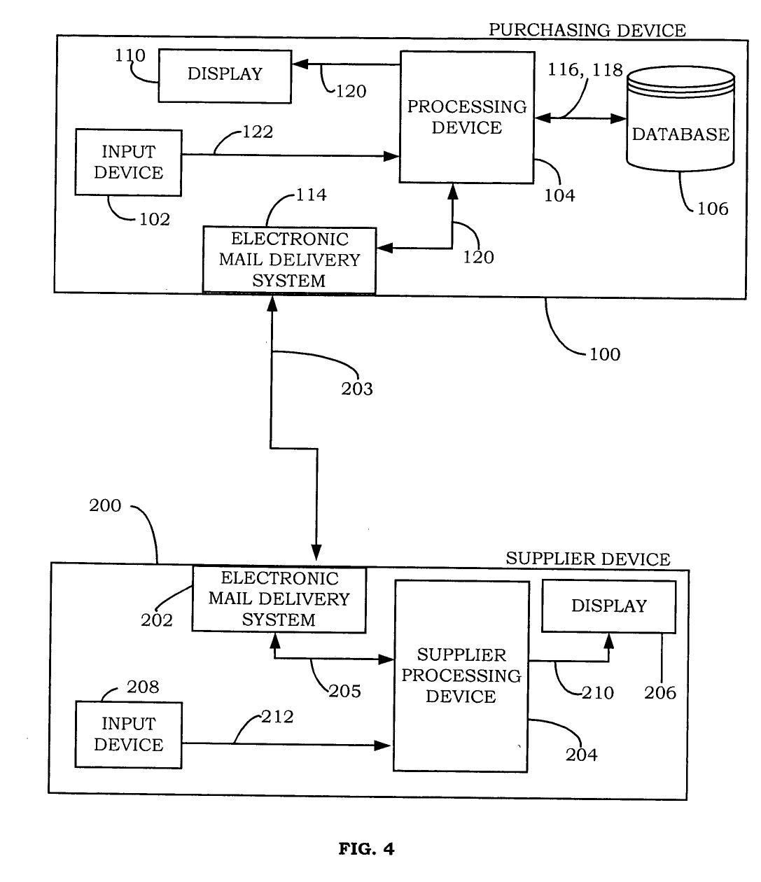

FIG. 4 illustrates a block diagram of a system allowing for contract term updates between a purchasing device 100, as described above in FIG. 1 and a supplier device 200. The purchasing device 100 includes the input device 102, the processing device 104, the database 106, the display 110 and the electronic mail delivery system 114.

The supplier device 200 includes an electronic mail delivery system 202, a supplier processing device 204, a display 206 and an input device 208. The electronic mail delivery system 202 may be any suitable system similar to the system 114 of the purchasing device 100 capable of receiving and transmitting electronic communications, including but not limited to a processing device executing operating instructions to performed the functions of electronic communication.

The purchasing device 100 is in operative communication with the supplier device 200 using any suitable communication technique, including but not limited to wired or wireless connections across public and/or proprietary networks. In one embodiment, the electronic mail delivery system 202 is operative to receive the update form in an electronic transmission 203 from the electronic delivery system 114 of the purchasing device 100.

The supplier processing device 204 is operative to receive an input signal 205 which includes either the update form from the electronic mail delivery system 202 or the signal 203 such that the processing device 204 is operative to extract the update form therefrom. The supplier processing device 204 provides an output 210 to the display 206 so that an operator using the supplier device 200, typically the supplier or the supplier and purchaser in a negotiation environment, may visually review the update form.

Concurrent with viewing the form, the supplier device 200 is operative to receive input commands in the input device 208 and provide input signals 212 to the supplier processing device 204. In one embodiment, the input device 208 may be a keyboard or keypad operative to receive keystrokes and the input signal 212 represents these inputs. In another embodiment, the input device 208 may be a touchscreen associated with the display 206. The supplier processing device 204 receives the input signal 212, wherein the input information relates to negotiated contract terms in the update form.

Upon completion of negotiating or re-negotiating the contract terms, the supplier processing device 204 is operative to provide the updated contract terms back to the electronic mail delivery system 202. Thereupon, the contract terms are provided to the purchasing device 100 through the electronic mail delivery system 114. These updated contract terms may then be provided back to the processing device 104 and updated within the database 106.

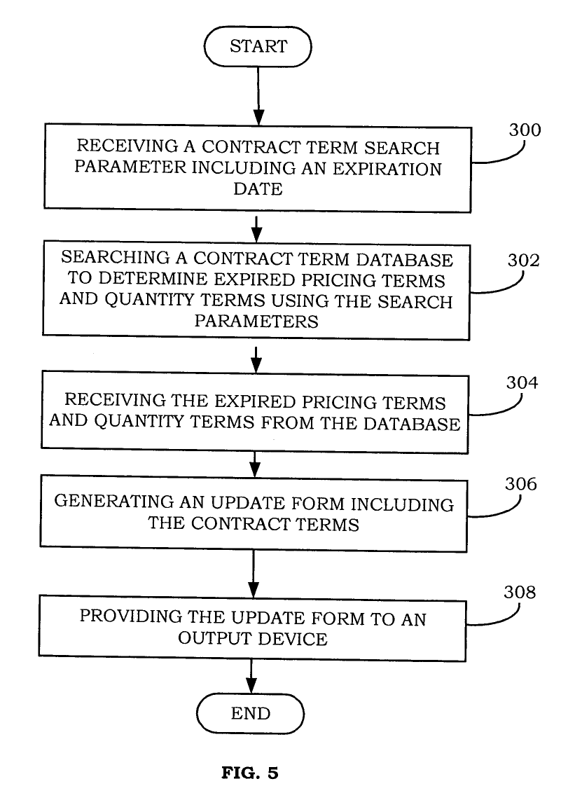

FIG. 5 illustrates a flowchart of the steps one embodiment of a method for determining contract terms needing to be updated. The method begins by receiving a contract term search parameter including an expiration date, step 300. The contract term search parameter may include a request for search and retrieval of contract information or may include limited parameter information, such as date information or purchaser/supplier information.

The next step is searching a contract term database to determine expired contract terms using the expiration date, step 302. This step may be performed by examining specific business objects having associated information relating to the contract and contract term expiration dates. As illustrated above in FIG. 2, the terms may have specific expiration dates, but an expiration date may further be applicable to the contract itself, thereby searching multiple contracts and/or specific contract terms in the database.

The next step is receiving the expired contract terms from the contract term database, step 304. In one embodiment, the contract term database may provide the full contract including all contract terms to the processing device. The data structure of the contract and contract terms may be consistent with a business object readable by the processing device. Therefore, the next step, step 306, is generating an update form including the contract terms. The update form, such as illustrated in FIG. 2, converts the contract terms into a human readable format by creating a tabular display of information.

In this embodiment, the next step, step 308, is providing the update form to an output device. This step may be performed by the processing device 104 converting the update form into a transmittable format. In one embodiment, the output device may be an electronic mail messaging system such that the update form is attached to or embedded within an electronic mail message. The output device may also be a printer allowing for printing of the human readable update form. As such, in this embodiment, the method is complete.

In other embodiments, the method described above in FIG. 5 may further include determining the expired contract terms by examining the expiration dates of the contract terms. As noted, the expired contract terms does not exclusively refer to contract terms currently expired but may also include terms nearing expiration, such as within an upcoming period of time. The determination may be performed using any suitable technique including comparing expiration dates of the contract terms with an expiration date or range of expiration dates.

Moreover, prior to providing the update form using the electronic mail message, the update form may be converted to be included within or attachable to the electronic mail message. This step may be performed using data manipulation operations to convert the update form into a software application format usable with the electronic mail delivery system, such as a commercially available third party software application.

In other embodiment, updated contract terms may be received via the electronic mail delivery system. The updated contract terms may be examined for errors, such as determining if the values are within a prescribed value range. The updated contract terms may then replace the expired terms in the contract database, thereby providing current contracts with current contract terms.

As such, contract term updates may be achieved through the automatic receipt of an update form. The update form includes expired contract terms and the update form is in a human readable form associated with an electronic message. The update form is interactive, allowing direct user input of updated terms and through the interactivity, allowing seamless integration of the updated contract terms into the contract database.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exists implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An apparatus for contract term updates, the apparatus comprising:
a database including data representing a plurality of contracts in which some of the contract terms have an expiration date;
a processing device in operative communication with the database, the processing device operative to receive contract terms from the database;
an output device in operative communication with the processing device; and
the processing device, in response to executable instructions, operative to:
query the database with an expiration date;
retrieve data of a plurality of contract terms responsive thereto;
generate an update form including the contract terms to be updated;
associate the update form to an electronic mail message; and
provide the update form to the output device using the electronic mail message.

2. The apparatus of claim 1, the processing device further operative to:
receive an input command including the expiration date.

3. The apparatus of claim 1 wherein the output device is an electronic mail delivery system, the processing device further operative to:
convert the update form into a transmittable form; and
provide the update form to the electronic mail delivery system.

4. The apparatus of claim 1 further comprising:
an input device operative to receive update contract terms; and
the processing device operative to:
integrate the updated contract terms within the contract.

5. The apparatus of claim 4 wherein the input includes the electronic mail delivery system such that at least one of: the processing device and the electronic mail processing system, is operative to read the electronic message and extract the updated contract terms.

6. The apparatus of claim 4 wherein the input device includes a data entry device such that the update contract terms are received from the data entry device.

7. The apparatus of claim 4 wherein the processing device is further operative to:
verify that the updated contract terms are within predefined contract term guidelines.

8. The apparatus of claim 1, the processing device further operative to generate contract search parameters and the database operative to receive the contract search parameters from the processing device such that the plurality of contract terms are retrieved using the contract search term parameters.

9. A method for electronically updating a contract, the method comprising:
comparing expiration dates of contract terms stored within a database to a search date;
receiving expired contract terms from the database based on the comparison;
generating an update form including the contract terms; and
providing the update form to an output device using an electronic mail message.

10. The method of claim 9 further comprising:
determining the expired contract terms by examining expiration dates of the contract terms.

11. The method of claim 10 wherein the expiration dates may include dates prior to a current date and dates within an upcoming time interval.

12. The method of claim 19, wherein the output device is an electronic mail delivery system, the method further comprising:
prior to providing the update form to the output device, converting the update form to be transmittable using the electronic mail delivery system.

13. The method of claim 9 further comprising:
receiving updated contract terms; and
replacing the updated contract terms with the expired contract terms in the contract term database.

14. The method of claim 13 wherein the updated contract terms are received through an electronic mail delivery system and the updated contract terms are associated with an electronic message such that the electronic message is read and the updated contract terms are extracted therefrom.

15. The method of claim 13 wherein the updated contract terms are received from a data entry device.

16. The method of claim 13 further comprising:
verifying of the updated contract terms such that the contract terms are within predefined acceptable guidelines.

17. A computer readable medium storing thereon programming instructions that when executed, cause an executing device to:
search a contract term database to determine expired contract terms using an expiration date;
receive the expired contract terms from the contract term database;
generate an update form including the at least one contract term; and
provide the update form to an output device using an electronic mail message.

18. The computer readable medium of claim 17 further comprising instructions that cause the executing device to:
determine the expired contract terms by examining expiration dates of the contract terms.

19. The computer readable medium of claim 17 further comprising instructions that cause the executing device to convert the update form to be transmittable using the electronic mail delivery system.

20. The computer readable medium of claim 17 further comprising instructions that cause the executing device to:
receive updated contract terms; and
replace the updated contract terms with the expired contract terms in the contract term database.

21. The computer readable medium of claim 20 further comprising instructions that cause the executing device to verify of the updated contract terms such that the contract terms are within predefined acceptable guidelines.

22. A system for electronically updating a contract, the system comprising:
a supplier device including:
a database including data representing terms of a plurality of contracts in which some of the contract terms have an expiration date;
a supplier processing device in operative communication with the database, the processing device operative to receive contract terms from the database;
an output device in operative communication with the processing device; and
the processing device, in response to executable instructions, operative to:
query the database with an expiration date;
retrieve data of a plurality of contract terms responsive thereto;
generate an update form including the contract terms to be updated; and
providing the update form to the output device; and
a purchasing device including:
a purchasing processing device, in response to executable instructions, operative to:
receive the update form from the output device.

23. The system of claim 22 further comprising:
the supplier processing device further operative to determine the contract terms to be retrieved for being updated based on at least the expiration dates of each of the contract terms.

24. The system of claim 23 wherein the output device is an electronic mail delivery system, the supplier processing device further operative to:
convert the update form into a transmittable form; and
provide the update form to the electronic mail delivery system.

25. The system of claim 24 wherein the purchasing device is further operative to:
receive the update form from the electronic mail delivery system; and
generate a plurality of updated contract terms.

26. The system of claim 25 wherein the purchasing device is further operative to transmit the plurality of updated contract terms to the supplier processing device.

27. The system of claim 26 further comprising:
an input device of the supplier device operative to receive updated contract terms and the supplier processing device operative to integrate the updated contract terms within the database.
